(19) United States
(12) Patent Application Publication
(10) Pub. No.: US 2005/0034271 A1
(43) Pub. Date: Feb. 17, 2005

(54) Reversible door handle

(76) Inventor: Andre Denys, Sterling Heights, MI (US)

Correspondence Address: Thomas N. Young;Yong & Basile, P.C., Suite 624, 3001 West Big Beaver Road, Troy, MI, 48084, US

(21) Appl. No.: 10/642,319

(22) Filed: Aug. 15, 2003

(51) Int. Cl. E05B 7/00

(52) U.S. Cl. 16/110.1

(57) ABSTRACT

A reversible handle assembly including a non-symmetrically shaped handle. The reversible handle is positionable in either the left hand or the right hand configuration and can be attached with spacer posts to either an escutcheon plate or to the surface of a door. The spacer post height can vary allowing adjustable profile heights.

### FIELD OF THE INVENTION

This invention relates to pull handles for sliding doors or the like, and more particularly to handles which can be installed in both left and right handed orientations.

### BACKGROUND OF THE INVENTION

Handles for sliding patio doors and the like are often left handed or right handed designs. To provide for both installations requires the manufacturer to manufacture two separate part numbers. The installer must then stock twice the part numbers as would otherwise be required if a given handle were non-handed. Reversible or “non-handed” designs are known, but are all symmetrical in design.

### SUMMARY OF THE INVENTION

The present invention provides a reversible handle assembly for patio doors or the like that includes a non-symmetrically shaped handle having first and second surfaces. The reversible handle can be positioned in either a left hand or a right hand configuration, such that either the first or second surface faces outwardly.

In one illustrative embodiment, the reversible handle assembly includes at least one post operable for spacing the handle apart from a mounting member such as an escutcheon plate or door and facilitates connecting the handle to the mounting member. Threaded fasteners extend from the underside of the escutcheon plate into one side of the post and an opposing threaded fastener extends through the reversible handle into the post from the other side of the assembly.

In another illustrative embodiment, the non-symmetrical handle includes a first portion substantially C-shaped with a relatively straight back side integrally formed with a second portion arcuately oriented in the opposite direction of the first portion.

In a still another illustrative embodiment, the non-symmetrical handle, includes a first portion formed in a ovalized shape and a second portion integrally extending from the ovalized portion. The second portion of the non-symmetrical handle is formed into a substantially J-shaped extension and is connectible to the mounting member.

In a still another illustrative embodiment of a non-symmetrical handle, the handle includes first and second portions formed of ovalized shapes and a third portion integrally extending between the first and second portions. The first ovalized portion is connectible to a mounting member in at least two locations and the second ovalized portion is connectible to the escutcheon plate in at least one location.

In a still another illustrative embodiment, the non-symmetrical handle includes a plurality of J-shaped members connectible with the escutcheon plate and a substantially linear member extending between the plurality of J-shaped members.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a perspective view of a non-symmetrical handle assembly;

FIG. 2 is an exploded view of a non-symmetrical handle assembly of FIG. 1;

FIG. 3 is a partial cross-sectional view of FIG. 1;

FIG. 4 is an exploded view of a second embodiment of a non-symmetrical handle assembly;

FIG. 4B is a partial cross-sectional view of FIG. 4;

FIG. 5 is an exploded view of a third embodiment of a non-symmetrical handle assembly;

FIG. 6 is a partial cross-sectional view of FIG. 5;

FIG. 7 is an exploded view of a fourth embodiment of a non-symmetrical handle assembly;

FIG. 8 is a partial cross-sectional view of FIG. 7;

FIG. 9 is an exploded view of a fifth embodiment of a non-symmetrical handle assembly;

FIG. 10 is a partial cross-sectional view of FIG. 9;

FIG. 11 is an exploded view of a sixth embodiment of a non-symmetrical handle assembly;

FIG. 12 is a partial cross-sectional view of FIG. 11;

FIG. 13 is a perspective view of a seventh embodiment of a non-symmetrical handle assembly;

FIG. 14 is a perspective view of an eighth embodiment of a non-symmetrical handle assembly; and

FIG. 15 is a perspective view of a ninth embodiment of a non-symmetrical handle assembly.

### DESCRIPTION OF THE PREFERRED EMBODIMENT

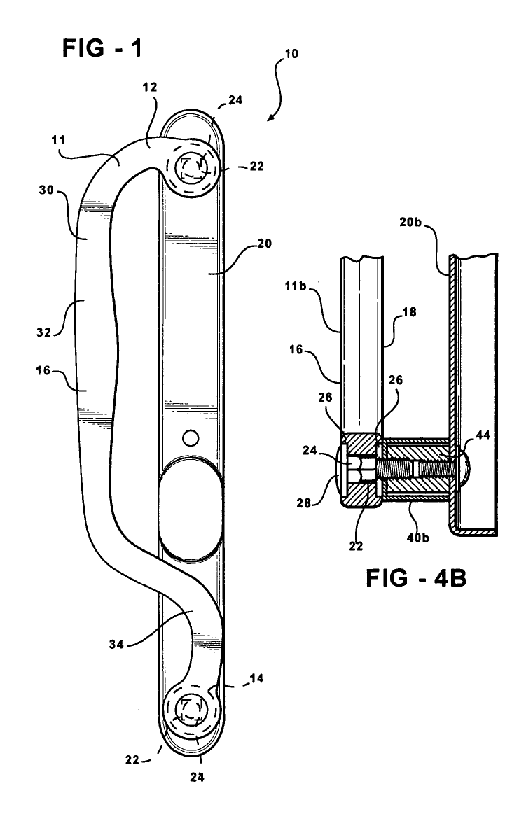

Referring now to FIGS. 1-3, a non-symmetrically shaped reversible or non-handed handle assembly 10 is shown therein. The non-symmetrical handle 11 includes first and second ends 12, 14 and first and second opposite, surfaces 16, 18. It should be understood that the cross section of the handle can be formed of any shape, including round or cylindrical. Even though in a geometrical sense, a cylindrical or round cross section forms only one surface, the first and second surfaces are defined as viewable surfaces from a perspective of left handed or right handed installation. The handle 11 is positionable in a left hand configuration as shown in FIG. 1 or, alternatively, in a right hand configuration (not shown) which will permit the first and second surfaces 16, 18 to be optionally installed in an outwardly facing position. The handle assembly 10 can include an escutcheon plate 20 for attaching the handle 11 thereto or alternatively the handle 11 can be attached directly to a door frame. Each end 12, 14 of the handle 11 includes through apertures 22 for receiving a threaded fastener 24 therethrough. Each through aperture 22 includes a counter sink 26 on each side 16, 18 of the handle 11. The counter sink 26 is operable for inserting a head 28 of the threaded fastener 24 substantially flush with an outer surface 16 or 18 of the handle 11.

In one embodiment of the present invention, the non-symmetrical handle includes a substantially C-shaped portion 30 with a substantially straight back portion 32. The C-shaped portion 30 is integrally formed with a second portion 34 arcuately oriented in the opposite direction with respect to the first portion 30.

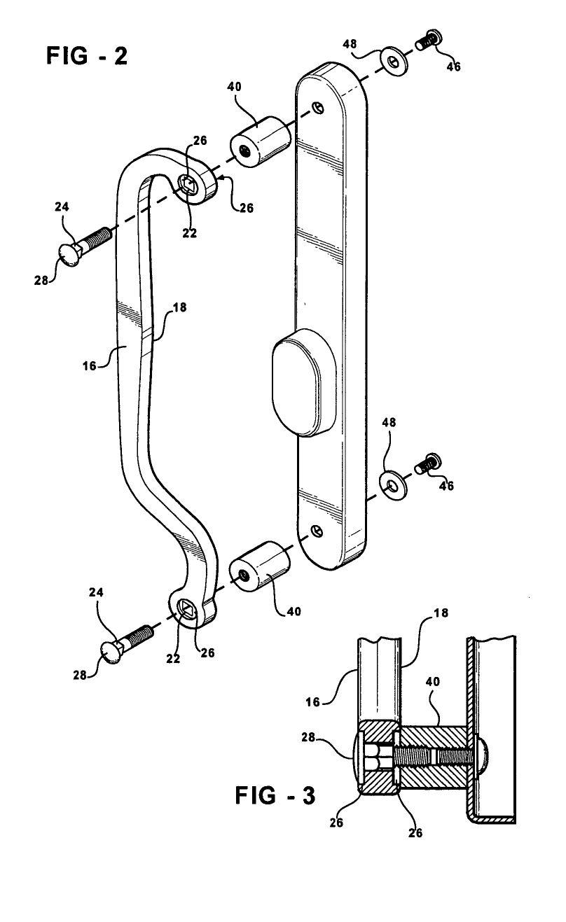

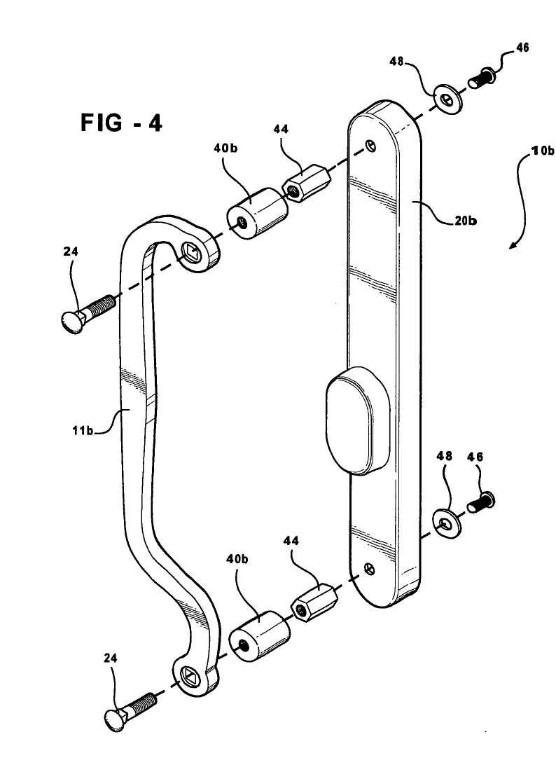

The reversible handle assembly 10 includes at least one connecting post 40 operable for spacing the handle 11 apart from a mounting member such an escutcheon plate 20 or a door frame (not shown). The spacing post 40 is internally threaded as shown in FIGS. 2 and 3 but can optionally be hollowed out in a second embodiment of the present invention as shown in FIGS. 4 and 4B.

The second embodiment of the handle assembly 10 is illustrated in FIGS. 4 and 4B. Handle assembly 10B requires an internally threaded barrel nut 44 which is positioned internally with respect to a hollow post 40B. Threaded fasteners 24 extend from the outer surface of the handle 11B and into the threaded barrel nut 44. The hollow post 40B and barrel nut 44 can be best utilized when the shape of the hollow post 40B is not round. A second pair of threaded fasteners 46 extend through the underside of the mounting member 20 and threadingly engage the threaded post 40 or the threaded barrel nut 44 depending on the particular design configuration. A plurality of washers 48 are included with the assembly to provide a flat seating surface for the threaded fasteners 46 to engage with when the fasteners 46 are tightened down. Again the handle can be installed with either surface facing outward.

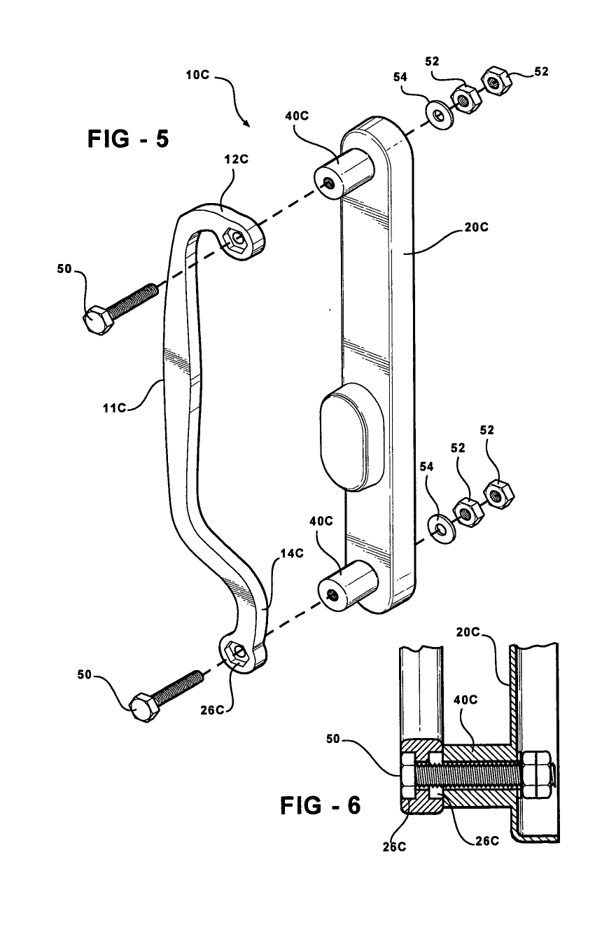

Referring now to FIGS. 5 and 6, a third alternate embodiment of the present invention is shown therein. The reversible non-symmetrical handle assembly 10C includes an escutcheon plate 20C with posts 40C integrally formed with the escutcheon plate 20C. In this configuration, a threaded fastener 50 extends through each end 12C, 14C of the handle 11C and can be threaded into the post 40C or extend completely therethrough and attached to the assembly 10C with a plurality of nuts 52 and washers 54.

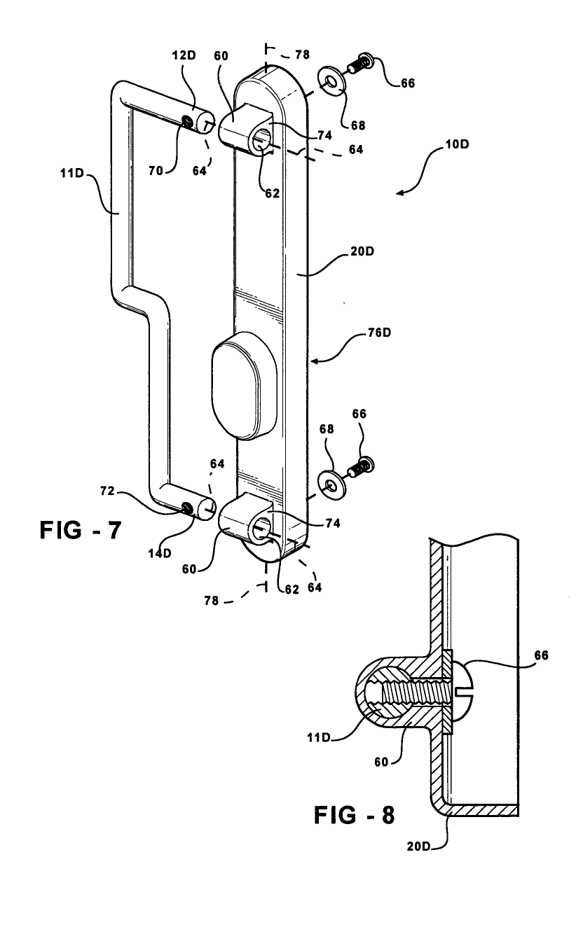

Referring now to FIGS. 7 and 8, a fourth embodiment of the present invention is shown therein. The reversible handle assembly 10D includes an escutcheon plate 20D and a pair of mounts 60 extending from the escutcheon plate 20D. The mounts 60 include through apertures 62 that define a longitudinal axis 64 for inserting the ends 12D, 14D of the handle 11D therein. The handle 11D is held within the mounts 60 with threaded fasteners 66 that threadingly engage through washers 68, the underside of escutcheon plate 20D and into threaded apertures 70, 72 located in the ends 12D, 14D of the handle 11D. The handle ends 12D, 14D can be positioned anywhere within the mounts 60, but are most preferably positioned substantially flush with an outer wall 74 of the mounts 60. The longitudinal axis 64 of the mounts 60 can be postitioned substantially orthogonally with respect to a longitudinal axis 78 of the escutcheon plate 20D as shown in FIG. 7 or alternatively can be substantially parallel to the longitudinal axis 78 of the escutcheon plate 20D.

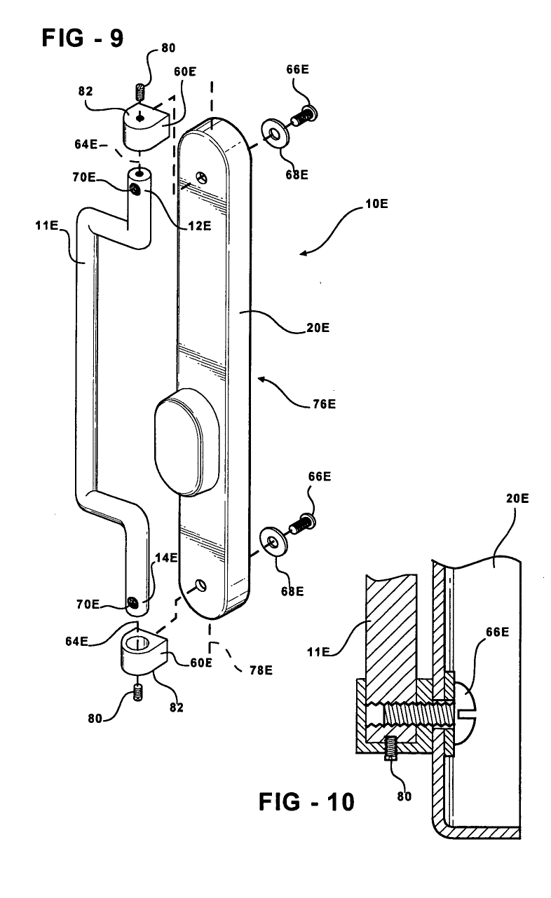

FIGS. 9 and 10 illustrate a fifth embodiment of the present invention. The mounts 60E are positioned such that a longitudinal axis 64E extends substantially parallel to the longitudinal axis 78E of the escutcheon plate 20E. A threaded fastener 66E extends through a washer 68E and the underside 76E of the escutcheon plate 20E and into threaded apertures 70E located on the ends 12E, 14E of the handle 11E. A set screw 80 extends through a side 82 of each mount 60E and into the ends 12E, 14E of the handle 11E to lock the handle 11E with respect to the mounts 60E.

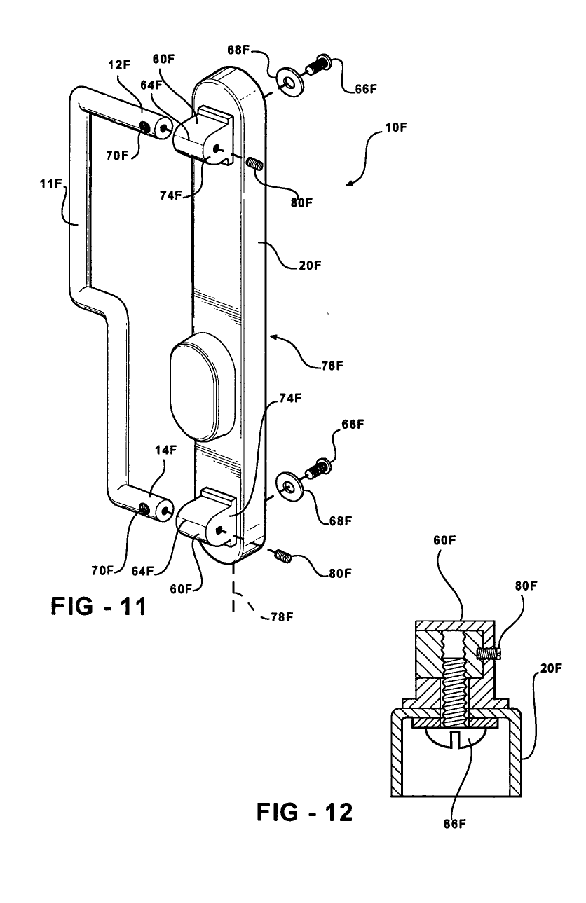

Referring now to FIGS. 11 and 12, the reversible handle assembly 10F is shown in a sixth configuration. The mounts 60F are positioned such that the longitudinal axis 64F is substantially orthagonal with respect to the longitudinal axis 74F of the escutcheon plate 20F. In this embodiment, the ends 12F, 14F of the handle 11F do not extend through the mounts 60F to become completely flush with one side 74F of the mounts 60F. A set screw 80F is utilized for locking each end 12F, 14F with respect to the mounts 60F. Threaded fasteners 66F extend through washers 68F and the underside 76F of the escutcheon plate 20F to threadingly engage with apertures 70F formed in the ends 12F, 14F of the handle 11F.

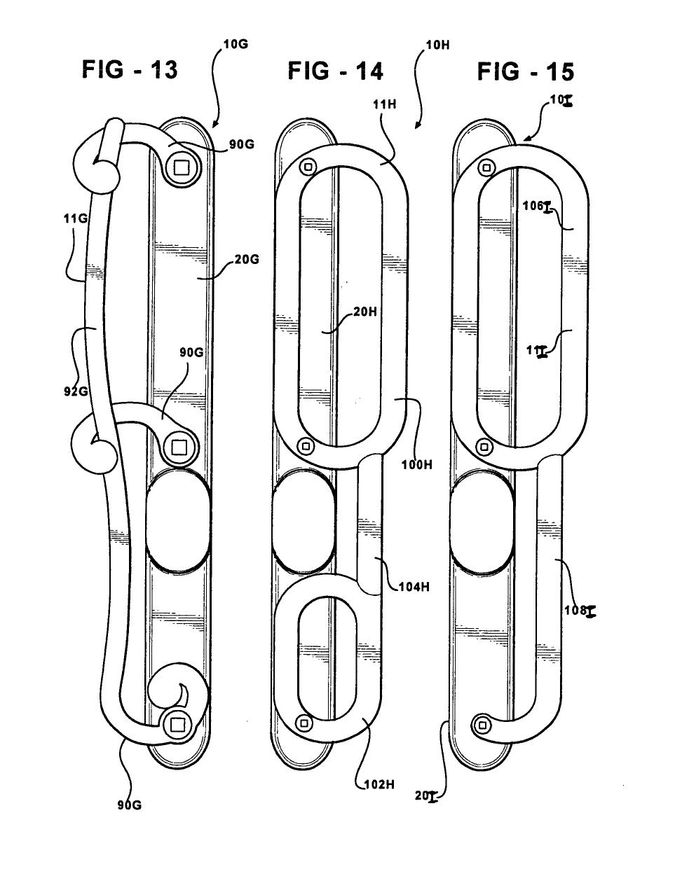

Referring now to FIG. 13, a seventh alternate embodiment of the reversible handle assembly 10G is shown therein. The non-symmetrical handle 11G includes a plurality of J-shaped members 90G connectible to an escutcheon plate 20G and a substantially linear member 92G extending between the plurality of J-shaped members 90G forming a handle 11G.

Referring now to FIG. 14, a eighth alternate embodiment of the reversible handle assembly 10H is shown therein. The non-symmetrical handle assembly 10H includes first 100H and second portions 102H formed in an ovalized shape and a third substantially linear portion 104H integrally extending between the first and second portions 1004, 102H.

In a ninth alternate embodiment of the reversible handle assembly, FIG. 15 shows a non-symmetrical handle assembly 10I that includes a first portion 106I formed in an ovalized shape and a second substantially J-shaped portion 108I integrally extending from the ovalized portion 106I.

The present inventions should not be considered as limited. The non-handed non-symmetrical handles are depicted in the drawings. These drawings are merely provided as some of the possible infinite number of configurations. In addition, the cross section of the handles and posts are shown as substantially round, but conceivable in any shape such as rectangular, square oval, triangular as contemplated by the present invention, along with any height allowing adjustable profile heights.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A reversible handle assembly comprising:
a non-symmetrically shaped handle having first and second ends and first and second surfaces, the handle positionable in one of a left and right hand configuration for permitting the first and second surfaces to be optionally installed in an outwardly facing position.

2. The reversible handle assembly of claim 1, wherein each handle comprises:
at least one through aperture for receiving a threaded fastener there through.

3. The reversible handle assembly of claim 2, wherein each through aperture of the handle further comprises:
a countersink for inserting a head of the threaded fastener substantially flush with an outer surface of the handle.

4. The reversible handle assembly of claim 1, wherein the non-symmetrical handle includes a first substantially C-shaped portion with a substantially straight back portion, the C-shaped portion being integrally formed with a second portion arcuately oriented in the opposite direction with respect to the first portion.

5. The reversible handle assembly of claim 1 further comprising:
at least one connecting post having first and second ends operable for spacing the handle apart from a mounting member.

6. The reversible handle assembly of claim 5, wherein the at least one post is internally threaded.

7. The reversible handle assembly of claim 6 further comprising:
a threaded fastener extendable through the underside of the mounting member for threadingly engaging the post.

8. The reversible handle assembly of claim 5 further comprising:
an internally threaded barrel nut positioned internally with respect the post.

9. The reversible handle assembly of claim 8 further comprising:
a threaded fastener extendable through underside of the mounting member for threadingly engageing the barrel nut.

10. The reversible handle assembly of claim 5, wherein the mounting member is defined by one of either a door and an escutcheon plate.

11. A reversible handle assembly comprising:
a non-symmetrically shaped handle having first and second ends and first and second surfaces, the handle positionable in one of a left and right hand configuration for permitting the first and second surfaces to be optionally installed in an outward facing position; and
an escutcheon plate have at least one post integrally exending therefrom for spacing the handle away from the escutcheon plate.

12. The reversible handle assembly of claim 11, wherein each handle comprises:
at least one through aperture for receiving a threaded fastener there through.

13. The reversible handle assembly of claim 111 further comprising:
a threaded fastener extendable through the handle and post for attaching the handle and post to the escutcheon plate.

14. The reversible handle assembly of claim 11, wherein each through aperture of the handle further comprises:
a countersink for inserting a head of the threaded fastener substantially flush with an outer surface of the handle.

15. The reversible handle assembly of claim 11, wherein the non-symmetrical handle includes a first substantially C-shaped portion with a substantially straight back portion, the C-shaped portion being integrally formed with a second portion arcuately oriented in the opposite direction with respect to the first portion.

16. A reversible handle assembly comprising:
a non-symmetrically shaped handle having first and second ends and first and second surfaces, the handle positionable in one of a left and right hand configuration for permitting the first and second surfaces to be optionally installed in an outwardly facing position.

17. The reversible handle assembly of claim 16, wherein each end of the handle comprises:
a through aperture for receiving a first threaded fastener therethrough.

18. The reversible handle assembly of claim 16 further comprising:
an escutcheon plate; and
a pair of mounts extending from the escutcheon plate, the mounts having through apertures defining a longitudinal axis for inserting the ends of the handle therein.

19. The reversible handle assembly of claim 18, wherein the handle ends are positioned substantially flush with an outer wall of the mounts.

20. The reversible handle assembly of claim 18 further comprising:
a threaded fastener extending through the mounts from the underside of the escutcheon plate for threadingly engaging the handle.

21. The reversible handle assembly of claim 18, wherein the longitudinal axis of the mounts are positioned substantially orthagonally with respect to a longitudinal axis of the escutcheon plate.

22. The reversible handle assembly of claim 18, wherein the longitudinal axis of the mounts are positioned substantially parallel with respect to a longitudinal axis of the escutcheon plate.

23. The reversible handle assembly of claim 18 further comprising:
a set screw extending through a side of each mount for threadingly engaging into the end of the handle.

24. The reversible handle assembly of claim 1, wherein the non-symmetrical handle includes a first portion formed in an ovalized shape and a second substantially J-shaped portion integrally extending from the ovalized portion.

25. The reversible handle assembly of claim 1, wherein the non-symmetrical handle includes first and second portions formed in ovalized shapes and a third portion integrally extending between the first and second portions.

26. The reversible handle assembly of claim 1, wherein the non-symmetrical handle includes a plurality of substantially J-shaped members connectable with the escutcheon plate and a substantially linear member extending between the plurality of J-shaped members.

27. A reversible handle for sliding patio doors and the like comprising:
a generally C-shaped but symmetrical handle portion having opposite ends and substantially identical opposite faces; and
means operatively associated with said opposite sides for mounting said handle on a door frame with either of said faces showing outwardly from said door.

28. A handle as defined in claim 27, wherein said faces are substantially flat and parallel.

29. A handle as defined in claim 27, wherein said faces are semi-cylindrical.
